(19) United States
(12) Patent Application Publication
(10) Pub. No.: US 2013/0318156 A1
(43) Pub. Date: Nov. 28, 2013

(54) DYNAMIC INFORMATION STREAMS IN A SOCIAL NETWORK PLATFORM

(71) Applicant: Klout, Inc., San Francisco, CA (US)

(72) Inventors: David Friedman, San Francisco, CA (US); Girish Lingappa, Sunnyvale, CA (US); Alexy Khrabrov, Oakland, CA (US); Jerome Banks, San Francisco, CA (US); Andras Benke, Novato, CA (US); Nemanja Spasojevic, San Francisco, CA (US); Adithya Shricharan Rao Srinivasa, San Francisco, CA (US); Ding Zhou, Milpitas, CA (US)

(21) Appl. No.: 13/900,878

(22) Filed: May 23, 2013

Related U.S. Application Data
(60) Provisional application No. 61/650,849, filed on May 23, 2012.

(51) Int. Cl. H04L 29/06

(52) U.S. Cl. CPC H04L 29/06047
USPC 709/203

(57) ABSTRACT

The techniques, methods and systems described herein facilitate the automated discovery and presentation of content created, published or otherwise made public by “experts” and key influencers on particular topics. As such, users that may be interested in particular topics but may not know who to connect with in order to receive the most pertinent information can receive highly-relevant information. Embodiments of the invention use topics of interest identified by the user and/or automatically identifies topics based on previous postings, communication, contacts, etc. Individuals, companies, organizations and other entities that have been recognized as highly influential in those topics are identified and, without explicit actions by the user, adds content generated by the influential entities to the user's content data feed.

### CROSS-REFERENCE TO RELATED APPLICATIONS

This application claims priority to and the benefits of U.S. provisional patent application Ser. No. 61/650,849, filed on May 23, 2012, the entire disclosure of which are incorporated herein by reference.

### FIELD OF THE INVENTION

The invention relates generally to the publishing of shared content across multiple disparate social networks and, more specifically, for identifying and implementing user-specific privacy policies on the shared content.

### BACKGROUND

Social networking platforms such as Facebook, Google+, FourSquare, LinkedIn, and Twitter have become deeply embedded into the social fabric of modern day life. These platforms support a variety of functions, ranging from sharing daily activities and photos to use as corporate advertising and marketing channels. Many individuals use these sites as sources of news and information about topics of interest such as current events, travel, sports, food, geographic areas, local news, etc. Moreover, companies use these channels to advertise promotions, sales, new products and services, as well as general information. In many instances the messaging and news feeds supplied by these platforms have become the de facto method of communication among and for large groups of individuals. This collection of data sent to and viewed by an individual is typically referred to as a “feed.” Recently, sites such as Klout, HootSuite, and Sprout Social have begun aggregating data fees from the individual social network platforms onto a single platform. This process provides a “global” view of content and its creators and illustrates how it proliferates across the web. Moreover, it allows multiple users who otherwise might not be connected to view and possibly comment on content submitted by others.

The items of an individual's feed typically includes a collection of posts, status updates, “check-ins” or other news stories that are pushed out onto the platform by an author. The author can be any entity, such as an individual person, a local business, a school group, a multi-national corporation, a government, or any group of people organized around a cause or topic. In order to receive this information, a user must make an explicit effort to become “linked to” or “follow” the author. This can be accomplished by requesting an individual as a friend or business link, subscribing to a news feed, requesting membership in a group, or similar action. In each case, however, the user must know at least something about who or what is a good source of information about their topic of interest. As a result, there may be many sources of information about a particular topic that exist on one or more social network platforms from which a user would benefit receiving information but has no definitive way of discovering.

There is a need, therefore, for methods and supporting systems that can identify authors and other sources of information regarding particular topics that have particular relevance and/or meet some minimum level of quality, and send the information to users without the user having to preemptively identify the source. Using such techniques would allow users to receive interesting and relevant information about their primary interests, current location and activities without having to necessarily know who the best sources of that information are.

### SUMMARY OF THE INVENTION

The techniques, methods and systems described herein facilitate the automated discovery and presentation of content created, published or otherwise made public by “experts” and key influencers on particular topics. As such, users that may be interested in particular topics but may not know who to connect with in order to receive the most pertinent information can receive highly-relevant information. The system uses topics of interest identified by the user and/or automatically identifies topics based on previous postings, communication, contacts, etc. In parallel, the system identifies individuals, companies, organizations and other entities that have been recognized as highly influential in those topics and, without explicit actions by the user, adds content generated by the influential entities to the user's content data feed. This results in the user receiving highly relevant information on topics that he would not have otherwise been privy to.

Therefore, in a first aspect, a method for providing a stream of data content items to a user of a social network platform includes storing, on a physical memory device, computer-executable instructions for identifying sources of content to be included in a content feed addressable to the user and providing content generated by the sources to the user. A processor is provided, that when used to execute the instructions identifies topics of interest of the user based on a list self-selected topics, topics identified from user-generated content provided by the user, the user's location (or future location), the user's activities (past, present and/or future) and/or previously selected content sources selected by the user. The instructions also identify content sources not previously known to the user as being relevant sources of information about the identified topics of interest and automatically includes content items generated by the identified content sources in the user's content feed.

In another aspect, a system for providing data content items to a user of a social network platform includes a data storage device for storing information related to topics of interest relevant to the user, a topic discovery engine and a content communications device. The topics of interest include a list self-selected topics, topics identified from user-generated content provided by the user, the user's location (or future location), the user's activities (past, present and/or future) and/or previously selected content sources selected by the user. The topic discovery engine identifies topics of interest of the user based at least in part on the stored information and identifies content sources not previously known to the user as relevant sources of information about the indentified topics of interest. The content communications device receives content items from the identified content sources and automatically includes the received content items in the user's content feed.

### BRIEF DESCRIPTION OF FIGURES

In the drawings, like reference characters generally refer to the same parts throughout the different views. Also, the drawings are not necessarily to scale, emphasis instead generally being placed upon illustrating the principles of the invention.

FIG. 1 is a diagram of the environment in which various embodiments of the invention operate.

FIG. 2 illustrates the creation, storage and analysis of user-generated content and activity data according to various embodiments of the invention.

FIG. 3 illustrates the general flow of information among components of a system supporting various embodiments of the invention.

FIG. 4 illustrates the collection and aggregation of data in order to create influence data and lists according to various embodiments of the invention.

FIG. 5 illustrates the functional components of a system for matching identified user interests with topics according to various embodiments of the invention.

FIG. 6 is an exemplary display of user generated content as processed by various embodiments of the invention.

FIG. 7 is a schematic of a system on which various embodiments of the invention may be implemented.

### DETAILED DESCRIPTION

A social networking platform generally consists of a website or a collection of websites and supporting applications, messaging capabilities, multimedia features, advertising, and content sharing functions. In some instances, the platform's purpose is simply social (e.g., the initial implementation of Facebook), whereas in other cases (e.g., LinkedIn) its purpose may be more professional. Increasingly, however companies, social causes, groups, political campaigns, even government entities have recognized the power of social media and use these platforms to disseminate information and gather information about and to the general public. In each case, these platforms generally offer its members the ability to communicate and interact with other members of the platform about topics of interest.

Typically, a user joins the social networking platform and adds “connections” or “friends” by searching for and identifying other members to whom they desire to be connected. In some cases, a connection may be established by a user electing to “follow” or become a “fan” of an entity through that entity's page. As used herein, the term “connection” refers to any other individual or entity to whom a member has formed an association or relationship via the website. Connections may be added explicitly by a member, for example, by the member specifying particular other member to connect with, or suggested by the social networking platform based on common characteristics of the members (e.g., members who work together or attended the same university, or have one or more friends in common). The connections may be bilateral, in that one member may request a connection with another, and that other individual must “approve” or “accept” the connection. In other instances, the connections may be unilateral in that a user may identify themselves as fan of a member—which is often the case with celebrities, brands, sports teams, media, etc. In either case, however, the user must take some explicit step to identify and connect with another member.

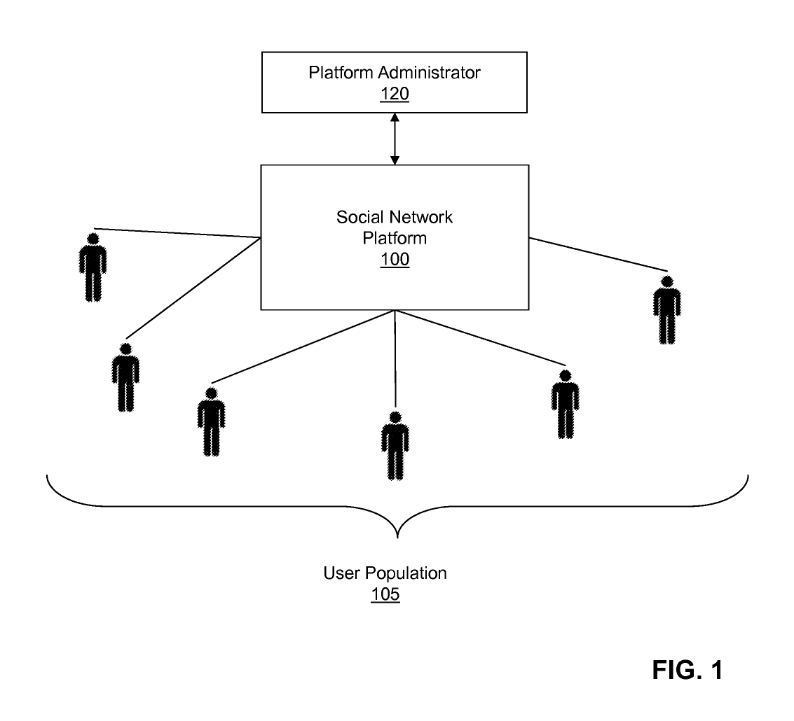

FIG. 1 illustrates, generally, one exemplary implementation of a social network platform 100 in which various embodiments of the invention operate. As described above, the social network platform 100 provides the infrastructure for members of a user population 105 to establish, manage and maintain connections among friends, family members, companies, media sources, brands, co-workers, classmates and other entities and/or individuals with whom they share a relationship or common interest. The platform 100 is typically managed and operated by an administrator 120 which, in some instances, may be responsible for implementing policies, procedures and other terms of use of the platform 100.

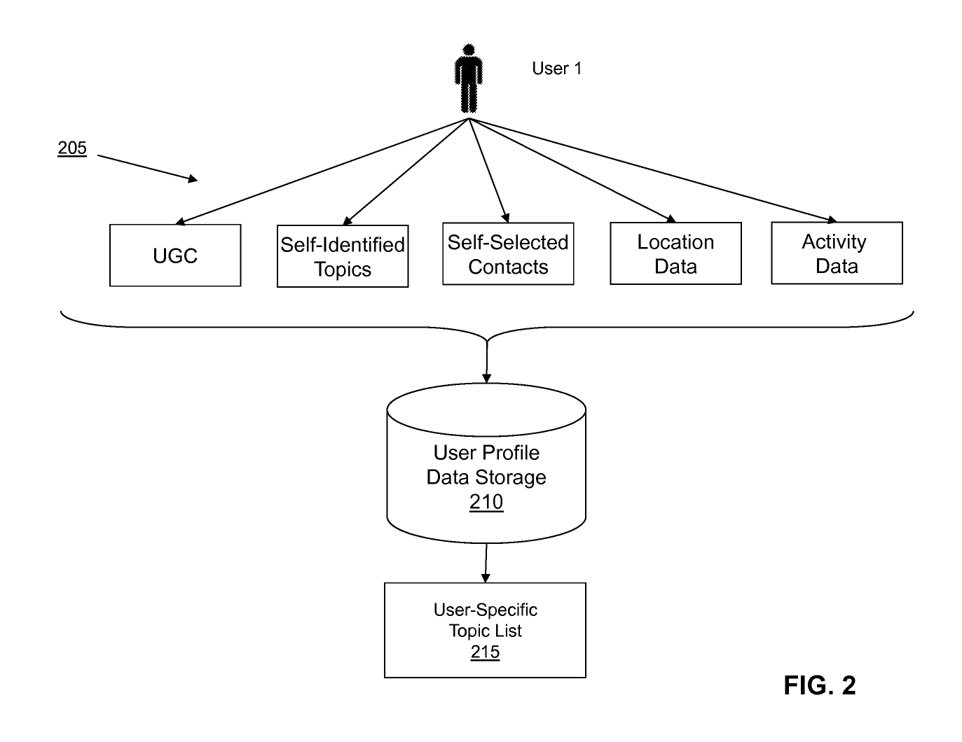

The social networking platform 100 monitors and captures various user interactions among members and with the platform itself. Referring to FIG. 2, for example, User 1's activities 205 may include creating and posting user-generated content (“UGC”), identifying topics of interest, requesting and/or confirming contacts, reposting content posted by others, posting location data (either explicitly by “checking in” at a location or implicitly be allowing the platform to have access to GPS data on a mobile device), and/or activity data (e.g., attending a concert, dining at a restaurant, at the beach, etc.). Virtually any action that the user takes with respect to another member or the platform itself is associated with the user. Other examples not illustrated but included in the profile may also include messaging other users, opening and/or reading messages from another user, viewing content, purchasing an item or service, attending an event, among others.

This collection of information 210 about the User may be collected and stored (typically in a physical database or data storage device) and used to create a member profile for each member of the platform. Based on the user profile data 210, one or more topics of interest may be determined. As noted above, the topics may be explicitly identified by the user (e.g., becoming a “fan” of a baseball team or singer) or implied based on a statistical analysis of the user data associated with their activities. The profile may be based, for example on a statistical analysis of the terms, phrases and words used by the user, meta data associated with the content created by, viewed by, or shared by the user. For example, if User 1 frequently reads content posted on the platform that is sourced from MSNBC and CNN Money, the platform may conclude that the individual has a stronger than average interest in the financial markets. As such, the User's profile may be annotated or otherwise associated with meta data, tags, or other data identifying topics of interest for that user.

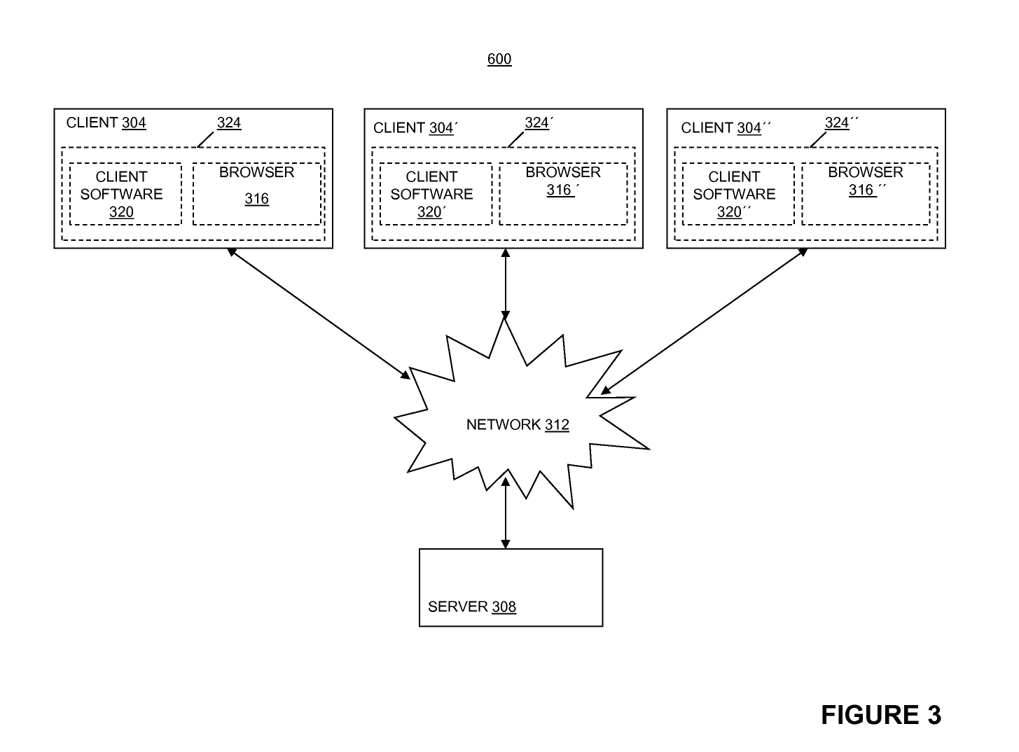

FIG. 3 is a block diagram illustrating one embodiment of a system environment suitable for operation of the social networking platform 100. The system environment comprises one or more client devices 304, the social networking platform server (or servers) 308, and a network 312. Those skilled in the art of designing, developing and implementing web-based applications recognize the numerous possible architectural arrangements of the various components and modules used in such systems. As shown, the platform interacts with three clients 304, 304′, and 304″, but this is exemplary and for demonstrative purposes, and it is intended that there can be any number of clients 304. The client 304 may be implemented as software running on a personal computer (e.g., a PC with an INTEL processor or an APPLE MACINTOSH) capable of running such operating systems as the MICROSOFT WINDOWS family of operating systems from Microsoft Corporation of Redmond, Wash., the MAC OS operating system from Apple Computer of Cupertino, Calif., and various varieties of Unix, such as SUN SOLARIS from SUN MICROSYSTEMS, and GNU/Linux from RED HAT, INC. of Durham, N.C. (and others). The client 304 may also be implemented on such hardware devices as a smart or dumb terminal, a point of sale device (POS), network computer, set top box, game player, mobile device, wireless device, wireless telephone, personal digital assistant, media (e.g., music and/or video) player, camera, information appliance, workstation, minicomputer, mainframe computer, or any other device with computing functionality. The client 304 may be operated as a general purpose computer or a special purpose hardware device.

In some embodiments, a client device 304 includes a web browser 316, client software 320, or both. The web browser 315 allows the client 304 to request a web page or other downloadable program, applet, or document (e.g., from the server 308) with a web page request. One example of a web page is a data file that includes computer-executable or interpretable information, graphics, sound, text, and/or video, that can be displayed, executed, played, processed, streamed, and/or stored and that can contain links, or pointers, to other web pages. In one embodiment, a user of the client 304 manually requests a web page from the server 308. Alternatively, in another embodiment, the client 304 automatically makes requests with the web browser 316. Examples of commercially available web browser software 316 are INTERNET EXPLORER, offered by Microsoft Corporation, CHROME, offered by Google Corporation, SAFARI, offered by Apple Corporation, or FIREFOX offered by the Mozilla Foundation.

In some embodiments, the client 304 also includes client software 320. The client software 320 provides functionality to the client 304 that maybe needed by the client device to execute one or more functions within the platform. The client software 320 may be implemented in various forms, for example, it may be in the form of an “app” purchased or downloaded from a central application service (e.g., Apple's AppStore) or, in some cases, a Java applet or program that is downloaded to the client 304 and runs in conjunction with the web browser 316. The client software 320 also may be in the form of a standalone application, implemented in a multi-platform language such as .Net or Java, or in native processor executable code. In one embodiment, if executing on the client 304, the client software 320 opens a network connection to the server 308 over the communications network 312 and communicates via that connection to the server 308. The client software 320 and the web browser 316 may be part of a single client-server interface 324; for example, the client software can be implemented as a “plug-in” to the web browser 316 and/or code that is downloaded and run within the framework of the web browser 316.

The communications network 312 connecting the clients 304 with the server 308 may be implemented via any media such as standard telephone lines, LAN or WAN links (e.g., T1, T3, 56kb, X.25), broadband connections (ISDN, Frame Relay, ATM), wireless links (802.11, Bluetooth, cellular, etc.), and so on, in any suitable combination. Preferably, the network 312 carries TCP/IP protocol communications, and HTTP/HTTPS requests made by the web browser 316 and the connection between the client software 320 and the server 308 may be communicated over such TCP/IP networks. The type of network is not a limitation, however, and any suitable network may be used. Non-limiting examples of networks that can serve as or be part of the communications network 312 include a wireless or wired Ethernet-based intranet, a local or wide-area network (LAN or WAN), and/or the global communications network known as the Internet, which may accommodate many different communications media and protocols.

The server 308 interacts with clients 304. The server 308 is preferably implemented on one or more server class computers that have sufficient memory, data storage, and processing power and that run a server class operating system (e.g., SUN Solaris, GNU/Linux, and the MICROSOFT WINDOWS family of operating systems). Other types of system hardware and software than that described herein may also be used, depending on the capacity of the device and the number of users and the size of the user base. For example, the server 308 may be implemented on, or may be part of, a logical group of one or more servers such as a server farm or server network. As another example, there may be multiple servers 308 that may be associated or connected with each other, or multiple servers could operate independently, but with shared data. In a further embodiment and as is typical in large-scale systems, the application software may be implemented in components and/or subgroups, with different components and/or subgroups running on different server computers, on the same server, or some combination.

As discussed above, the social networking platform maintains data about a number of different types of interactions the users have with each other across various social network platforms, the platform itself, content, and other entities using the platform. In some instances, the platform may aggregate data from multiple sources, e.g., other social networking platforms, email databases, messaging platforms (e.g., Twitter), news aggregation sites (e.g., Digg, Reddit, Slashdot) and public news feeds, etc. Together, the content comprises a significant amount of information about an individual, and users can be identified as being particularly influential based on the information.

Similar to the user profile described above, a user's “influence” can be measured by the amount, frequency, and quality of the content associated with that user. In some instances the user's influence may be “global”—e.g., an influence metric may be based generally on the number of connections a user has, the frequency their tweets or status updates are shared, the number of fans they have, and other similar parameters that are topic agnostic. In some instances, however, a user's influence may be topic-specific—that is a particular user may be deemed an expert in a particular field of study (math, programming), cultural interests (music, movies, right-wing politics, Indian cuisine), geography (Paris, Napa Valley vineyards, South Pacific Beaches) or some combination of these (e.g., Indian restaurants in the Hell's Kitchen neighborhood of New York City). A user's influence may, in some cases, evolve over time as they become more of an expert, or, alternatively, as their influence and knowledge of a certain topic wanes.

Although similar to a user profile described above that is based solely on a user's actions, the influence a user has regarding a particular topic may be weighted more heavily by the actions of others, rather than the individual himself. As an example, a user may tout themselves to be the best source of information about PHP scripting, but another user may have a high karma score on Slashdot because other users repeatedly upvote his code posts and have a large number of Twitter followers. It is likely that the second user, while more modest about their skills, is actually more influential about PHP scripting that the self-proclaimed expert.

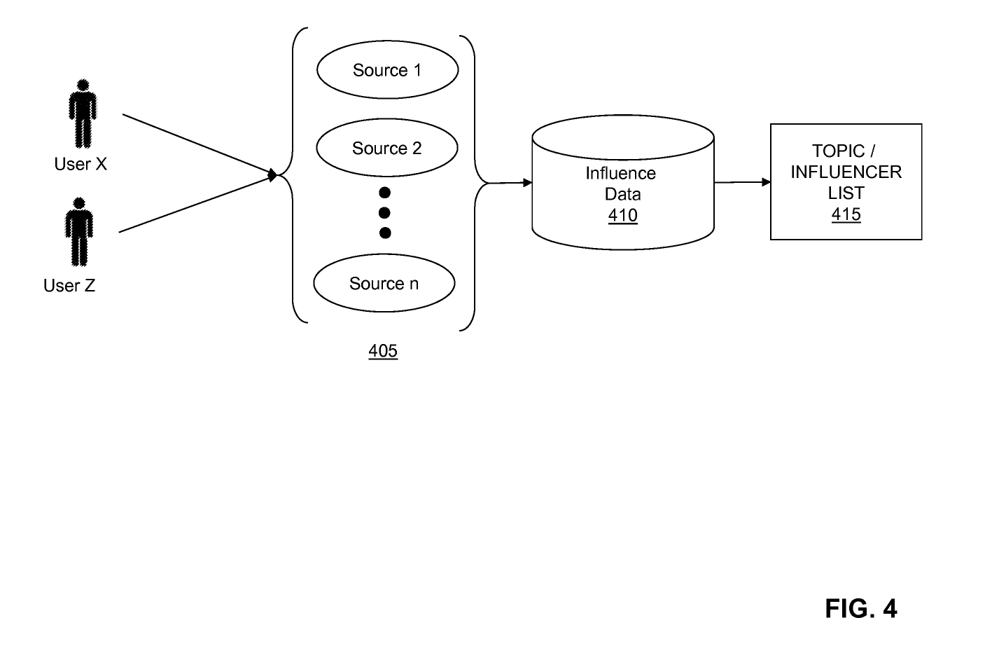

Referring now to FIG. 4, user data is collected from multiple sources 405 (e.g., Facebook friends, Twitter followers, LinkedIn connections, YouTube channel subscribers, re-Tweet statistics, Slashdot and/or Reddit karma, etc.) and aggregated and scored as influence data 410. Based on the influence data, a topic/user pairing list 415 is compiled that identifies users that have particularly high influence regarding certain topics. In various embodiments, the pairings may be hierarchical in nature, multi-dimensional, or take on other forms of relationships. For example, a paring may indicate that a user is influential in the topic of “sports” and highly influential in the topic of “baseball.” More specifically, the user may be highly knowledgeable about baseball rules, or card collecting, or some other subtopic related to baseball, meaning the dimensionality of the topics are related. Conversely, the dimensions may be unrelated, as is the case when a user is influential in a specific topic “Indian Food” but only related to a certain geography “Cambridge, Mass.”

The list may contain a limited number of pairings (e.g., only the top three individuals about a particular topic, or the top 100 influential users about a predefined number of topics), or in some cases continue to expand as new topics and influencers are identified. In each case, however, the collection and analysis of the data results in a non-self-selected list of users that are “vetted” as experts in a particular field based on statistical data collected from one or more sources.

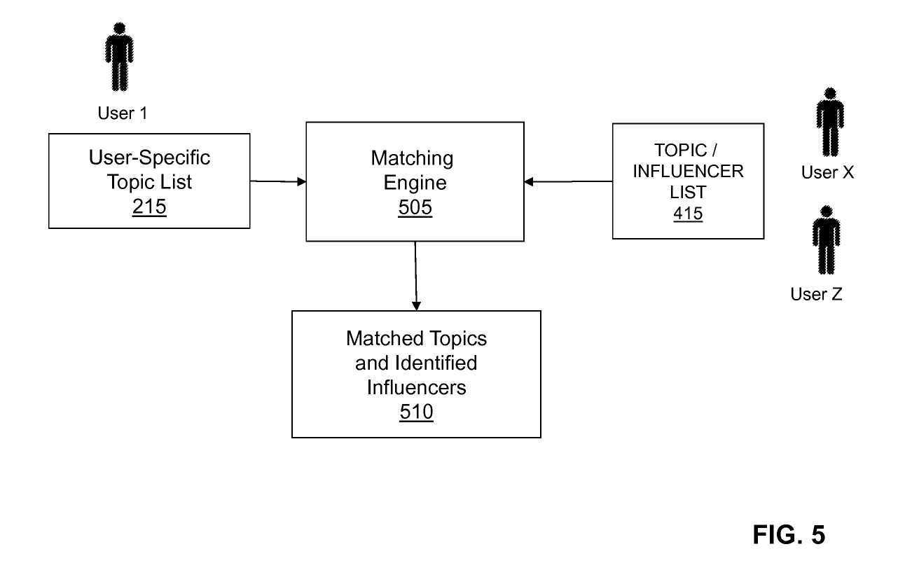

FIG. 5 illustrates one method that the combination of the user-specific topic list 215 and the topic/influencer list 415 are used to automatically identify sources of potentially interesting and relevant content for users without the user having to search for, friend, follow or connect with the source. A matching engine 505 is provided that compares the topics identified in the user-specific topic list 215 with those culled from the influence data and stored in the topic/influencer list 415. The matching algorithm may look for exact matches (e.g., “house music”) or, in other cases, an approximate or probabilistic “fuzzy logic” approach for identifying matches. For example, if three topics, sushi, the San Francisco Giants, and paddle boarding, have been identified as of particular interest to a user, the matching engine will search through the topic/influencer list 415 for users that are influential in those topics. If, however, no users are identified as highly influential in one of the topics (e.g., sushi) the matching engine may instead select a user deemed influential in Japanese restaurants. In some cases, the matching engine may further limit the users identified as a match, especially in cases where a large number of experts are identified. For example, if the user's topic of interest was baseball (instead of the San Francisco Giants), but the user lived in San Francisco, the matching engine might select a user deemed influential about baseball from the Bay Area (User X) over a user equally (or, in some cases more) influential in baseball but living in Boston (User Z). In each case the result is an automatically generated list of “matches” or “connections” 510 between two users that otherwise would not be connected.

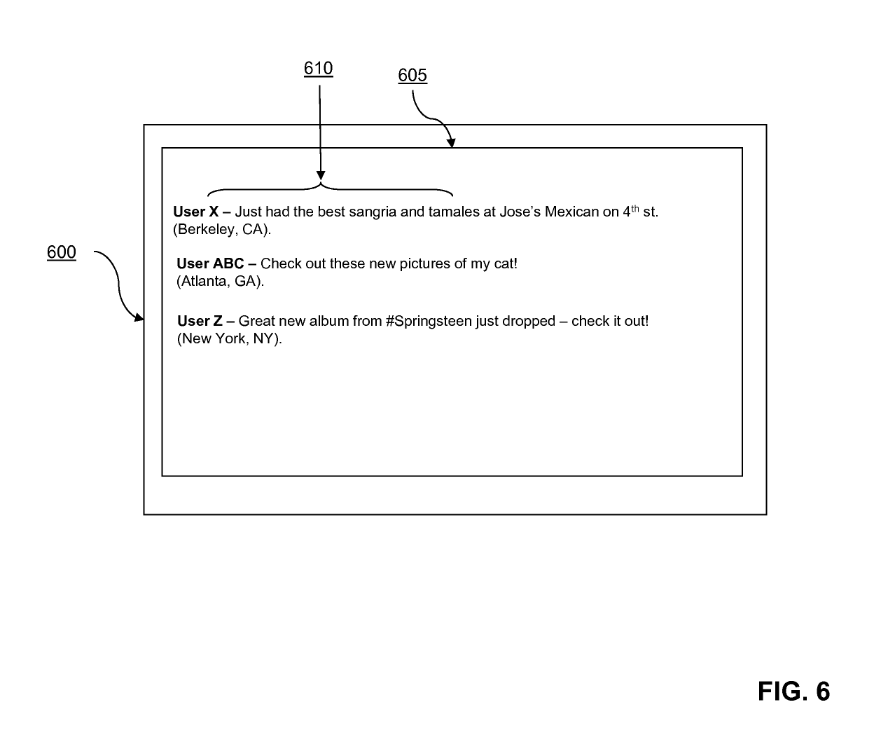

Once topic-specific influential users are matched with users looking for information about the particular topics, the user's news feed may be annotated with news, posts, tweets, or other content. Referring to FIG. 6, for example, an application user interface 600 may be presented to the user as part of the social network platform 100, or as part of a general content presentation application. The user interface 600 may be presented on a conventional computer monitor or, in some cases a smartphone or other mobile device. The interface 600 includes a stream of content 605, or news feed, that lists content 610 posted or provided by other members of the platform. In conventional implementations, the content provided in the news feed is limited to items posted by members to whom the user is already connected. However, using the methods and systems described herein, the content news feed is enhanced by the addition of content from sources that the user may not know of, but, because of their interests, content provided by certain individuals our sources deemed to have significant influence on that topic is also included. For example, the user whose feed 605 is depicted in FIG. 6 may be friends with User ABC, and have explicitly connected with that individual by requesting and/or confirming the connection. However, the platform may imply from the user's recent activities that she is a fan of Mexican food, frequents restaurants in Berkeley, Calif. and listens to Bruce Springsteen. By identifying users that are deemed to be influential on those topics, Users X and X's content is added to her news feed. This allows the user to learn about topics that are important to her from those that have been statistically vetted as experts in those areas.

In some instances, the user may decide that an user deemed to be an expert does not share her tastes, or has questionable judgment regarding Mexican food, and therefore can apply a filter to her news feed to eliminate posts from User X. In some cases, a different influential user's content may be added to her feed, whereas in others no new content is added.

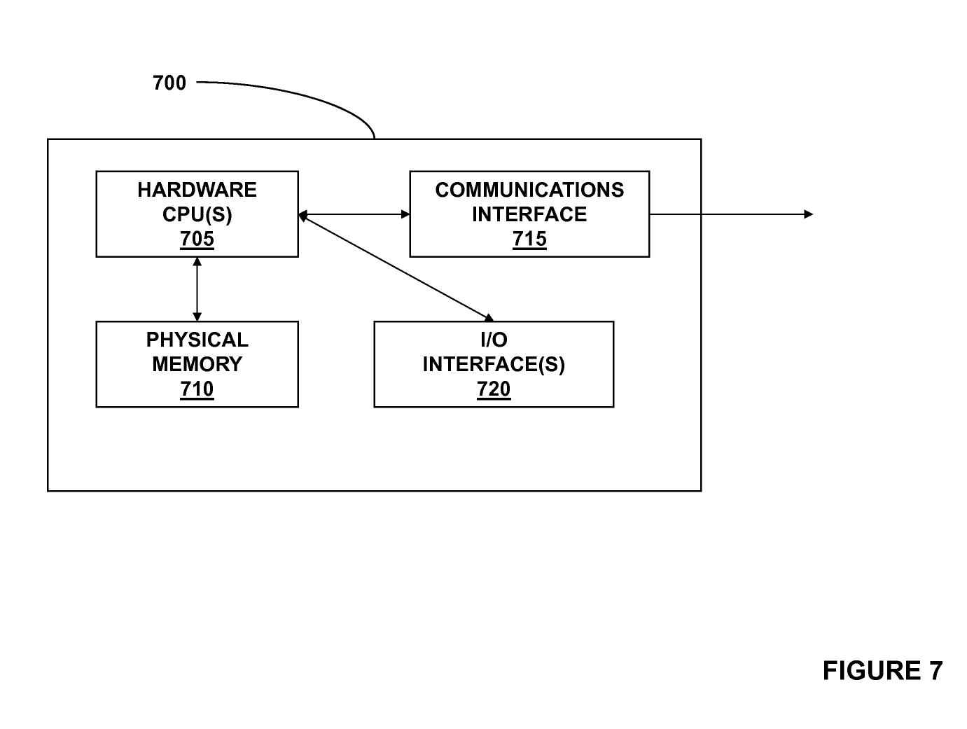

Referring to FIG. 7, those skilled in the art will appreciate that various implementations of the invention may be practiced with various computer system configurations, including hand-held wireless devices such as mobile phones or personal digital assistants (PDAs), multiprocessor systems, microprocessor-based or programmable consumer electronics, minicomputers, mainframe computers, and the like.

The invention may also be practiced in distributed computing environments where tasks are performed by remote processing devices that are linked through a communications network. In a distributed computing environment, program modules may be located in both local and remote computer storage media including memory storage devices.

In some cases, relational (or other structured) databases may provide data storage and management functionality, for example as a database management system or database server which stores data related to the services and consumers utilizing the service. Examples of databases include the MySQL Database Server or ORACLE Database Server offered by ORACLE Corp. of Redwood Shores, Calif., the PostgreSQL Database Server by the PostgreSQL Global Development Group of Berkeley, Calif., or the DB2 Database Server offered by IBM.

The computer system may include a general purpose computing device 700 in the form of a computer including a processing unit 705, a system memory 710, and a system bus that couples various system components including the system memory to the processing unit.

Computers typically include a variety of computer readable media that can form part of the system memory 710 and be read by the processing unit 705. By way of example, and not limitation, computer readable media may comprise computer storage media and communication media. The system memory may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by processing unit. The data or program modules may include an operating system, application programs, other program modules, and program data. The operating system may be or include a variety of operating systems such as Microsoft Windows® operating system, the Unix operating system, the Linux operating system, the Xenix operating system, the IBM AIX™ operating system, the Hewlett Packard UX™ operating system, the Novell Netware™ operating system, the Sun Microsystems Solaris™ operating system, the OS/2™ operating system, or another operating system of platform.

At a minimum, the memory 710 includes at least one set of instructions that is either permanently or temporarily stored. The processor 705 executes the instructions that are stored in order to process data. The set of instructions may include various instructions that perform a particular task or tasks. Such a set of instructions for performing a particular task may be characterized as a program, software program, software, engine, module, component, mechanism, or tool.

The system may include a plurality of software processing modules stored in a memory as described above and executed on the platform 100. The program modules may be in the form of any suitable programming language, which is converted to machine language or object code to allow the processor or processors to read the instructions. That is, written lines of programming code or source code, in a particular programming language, may be converted to machine language using a compiler, assembler, or interpreter. The machine language may be binary coded machine instructions specific to a particular computer.

Any suitable programming language may be used in accordance with the various embodiments of the invention. Illustratively, the programming language used may include assembly language, Ada, APL, Basic, C, C++, COBOL, dBase, Forth, FORTRAN, Java, Modula-2, Pascal, Prolog, REXX, and/or JavaScript, for example. Further, it is not necessary that a single type of instruction or programming language be utilized in conjunction with the operation of the system and method of the invention. Rather, any number of different programming languages may be utilized as is necessary or desirable.

The computing environment may also include other removable/non-removable, volatile/nonvolatile computer storage media. For example, a hard disk drive may read or write to non-removable, nonvolatile magnetic media. A magnetic disk drive may read from or writes to a removable, nonvolatile magnetic disk, and an optical disk drive may read from or write to a removable, nonvolatile optical disk such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

The processing unit that executes commands and instructions may be a general purpose computer, but may utilize any of a wide variety of other technologies including a special purpose computer, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID integrated circuits, smart chip, or any other device or arrangement of devices that is capable of implementing the steps of the processes of the invention.

It should be appreciated that the processors and/or memories of the computer system need not be physically in the same location. Each of the processors and each of the memories used by the computer system may be in geographically distinct locations and be connected so as to communicate with each other in any suitable manner via, for example, a communications interface 715. Additionally, it is appreciated that each of the processor and/or memory may be composed of different physical pieces of equipment.

A user may enter commands and information into the computer through one or more user device interfaces 720 that communicate with input devices such as a keyboard and pointing device, commonly referred to as a mouse, trackball or touch pad. Other input devices may include a microphone, joystick, game pad, satellite dish, scanner, voice recognition device, keyboard, touch screen, toggle switch, pushbutton, or the like. These and other input devices are often connected to the processing unit through a user input interface that is coupled to the system bus, but may be connected by other interface and bus structures, such as a parallel port, game port or a universal serial bus (USB).

One or more monitors or display devices (not shown) may also be connected to the system bus via an interface. In addition to display devices, computers may also include other peripheral output devices, which may be connected through an output peripheral interface. The computers implementing the invention may operate in a networked environment using logical connections to one or more remote computers, the remote computers typically including many or all of the elements described above.

Although internal components of the computer are not shown, those of ordinary skill in the art will appreciate that such components and the interconnections are well known. Accordingly, additional details concerning the internal construction of the computer need not be disclosed in connection with the present invention.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology.

What is claimed is:

1. A method for providing a stream of data content items to a user of a social network platform, the method comprising the steps of:
storing, on a physical memory device, computer-executable instructions for identifying sources of content to be included in a content feed addressable to the user and providing content generated by the sources to the user; and
providing a processor for accessing and executing the instructions, that when executed by the processor
(i) identifies topics of interest of the user based at least in part on one or more of:
(a) a list self-selected topics;
(b) a list of topics identified from user-generated content provided by the user;
(c) a location of the user;
(d) an activity of the user; and
(e) one or more previously selected content sources selected by the user;
(ii) identifies content sources not previously known to the user as relevant sources of information about one or more of the identified topics of interest; and
(iii) automatically includes content items generated by the identified content sources in the user's content feed.

2. A system for providing data content items to a user of a social network platform, the system comprising:
(i) a data storage device for storing information related to topics of interest relevant to the user, wherein the topics of interest include one or more of
(a) a list self-selected topics;
(b) a list of topics identified from user-generated content provided by the user;
(c) a location of the user;
(d) an activity of the user; and
(e) one or more previously selected content sources selected by the user;
(ii) a topic discovery and matching engine for identifying topics of interest of the user based at least in part on the stored information and identifying one or more content sources not previously known to the user as relevant sources of information about the identified topics of interest; and
(iii) a content communications device for receiving content items from the identified content sources and automatically including the received content items in the user's content feed.
